(19) United States
(12) Patent Application Publication
(10) Pub. No.: US 2022/0041036 A1
(43) Pub. Date: Feb. 10, 2022

(54) TORQUE TRANSMISSION DEVICE

(71) Applicant: MAHLE International GmbH, Stuttgart (DE)

(72) Inventors: Jochen SCHAUDT, Hechingen (DE); Ralf REIN, Marbach (DE); Thomas FREY, Boebingen an der Rems (DE); Nico HELD, Esslingen (DE)

(73) Assignee: MAHLE International GmbH, Stuttgart (DE)

(21) Appl. No.: 17/396,052

(22) Filed: Aug. 6, 2021

(30) Foreign Application Priority Data
Aug. 7, 2020 (DE) 10 2020 210 029.2

(51) Int. Cl. B60H 1/00; F16H 21/54; F16H 51/00; F16C 11/04

(52) U.S. Cl. CPC B60H 1/00835; F16C 11/04; F16H 51/00; F16H 21/54

(57) ABSTRACT

A torque transmission device, in particular for a flap of a heating, ventilation, or air conditioning system of a motor vehicle, having a drive lever, an output lever, and having a connecting rod, wherein the drive lever can be rotatably disposed with respect to a first axis and can be connected to a driving element, wherein the output lever can be rotatably disposed with respect to a second axis and can be connected to an element to be driven, wherein the connecting rod is connected in an articulated manner to the drive lever and to the output lever, wherein the connecting rod is formed connected to the drive lever and/or to the output lever by means of a film hinge.

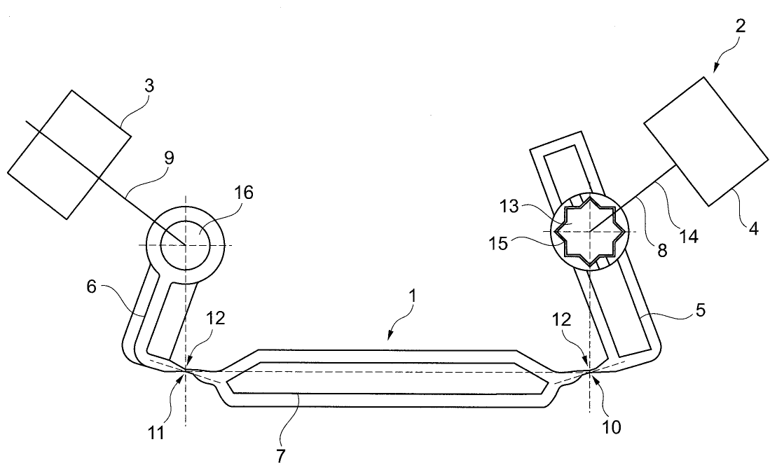

This nonprovisional application claims priority under 35 U.S.C. § 119(a) to German Patent Application No. 10 2020 210 029.2, which was filed in Germany on Aug. 7, 2020 and which is herein incorporated by reference.

### BACKGROUND OF THE INVENTION

### Field of the Invention

The present invention relates to a torque transmission device, in particular for a flap of a heating, ventilation, or air conditioning system of a motor vehicle or for another movable element.

### Description of the Background Art

In the state of the art, heating, ventilation, or air conditioning systems for motor vehicles are known in which flaps are driven by a drive motor or a Bowden cable by means of a torque transmission device with a four-bar chain. In this regard, a connecting rod is used between a drive lever, which is connected to the drive motor in a torque-transmitting manner, and an output lever, which is connected to the flap to be rotated in a torque-transmitting manner, and is connected to the drive lever, on the one hand, and to the output lever, on the other hand, via an articulated connection. In this regard, the connecting rod is connected in an articulated manner to the respective drive lever or output lever either by means of ball head connections or by means of pin-type connections. These types of connections allow a quick and uncomplicated connection of the connecting rod to the respective drive lever or output lever, so that it is possible to work efficiently in terms of time during assembly.

However, it is also evident with this type of connection that the play in the joints between the drive lever and the connecting rod and between the output lever and the connecting rod has a detrimental effect on the positioning accuracy of the flap to be moved, which leads to increased hysteresis. It is also evident that the use of the three components, drive lever, output lever, and connecting rod, entails corresponding costs due to storage and logistics.

### SUMMARY OF THE INVENTION

It is therefore an object of the present invention to provide a torque transmission device, in particular for a flap of a heating, ventilation, or air conditioning system of a motor vehicle or otherwise, which is improved over the torque transmission devices in the state of the art with regard to positioning accuracy and the arising hysteresis and is also improved with regard to the costs and, optionally, a simplified automated assembly is also made possible. It is also the object to create a heating, ventilation, or air conditioning system for a motor vehicle which is improved with regard to any hysteresis in the actuation mechanism and with regard to the costs and the ability to automate the assembly.

An exemplary embodiment of the invention relates to a torque transmission device, in particular for a flap of a heating, ventilation, or air conditioning system of a motor vehicle, having a drive lever, an output lever, and having a connecting rod, wherein the drive lever can be rotatably disposed with respect to a first axis and can be connected to a driving element so that it can reduce torque, wherein the output lever can be rotatably disposed with respect to a second axis and can be connected to an element to be driven so that it can output torque, wherein the connecting rod is connected in an articulated manner to the drive lever and to the output lever, wherein the connecting rod is formed connected to the drive lever and/or to the output lever by means of a film hinge. By providing the at least one film hinge, hysteresis can be significantly reduced or prevented and at the same time the number of parts to be installed is reduced, which lowers the costs.

It is especially advantageous in this regard if the connecting rod is formed connected to the drive lever and to the output lever in each case by means of a film hinge. By providing the two film hinges, hysteresis is significantly reduced or prevented and at the same time the number of parts to be installed is reduced, which lowers the costs. The drive lever, output lever, and the connecting rod are formed as one part.

It is especially advantageous if the connecting rod and the drive lever are formed in one piece or the connecting rod and the output lever are formed in one piece or the connecting rod, the drive lever, and the output lever are formed in one piece. This reduces the number of parts used accordingly, which lowers the costs, in particular the assembly and logistics costs, and it allows automated assembly, because there is no need to connect different individual parts due to the one-piece design. The product quality is also increased because unintentional loosening of individual parts is prevented by the one-piece design.

It is also expedient if the connection, not formed as a film hinge, between the connecting rod and the drive lever or with the output lever is made as a positive connection, such as, for example, a ball head, pin, bayonet, clip, or plug connection. A simplified assembly can be achieved additionally in this way.

It is also advantageous if the connecting rod and/or the drive lever and/or the output lever are produced as plastic parts, in particular as injection molded parts. As a result, an effective production and a one-piece design can be achieved, in particular if the integrated part can be produced from an injection molding process.

It is also expedient if the drive lever has a receptacle and/or a connecting element for connecting a drive shaft of a driving element. A simple connection can thus be made by insertion or pushing on, etc., which simplifies the assembly process and thus also saves costs.

The driving element can be an actuator, a stepper motor, an electric motor, a Bowden cable, etc. In this way, in particular, effective control and positionally precise actuation can be carried out or a cost-effective actuation can be carried out.

It is also expedient if the output lever has a receptacle and/or a connecting element for connecting to an element to be driven, in particular to a flap, a water valve, a guide part, or another movable component to be driven, etc. A simple connection can thus be made by insertion or pushing on, etc., which simplifies the assembly process and thus also saves costs.

An exemplary embodiment of the invention also relates to a heating, ventilation, or air conditioning system of a motor vehicle with a flap for controlling an airflow in an air duct and with a drive motor for actuating the flap, wherein a torque transmission device of the invention is provided, wherein the torque transmission device is formed with a drive lever, an output lever, and with a connecting rod, wherein the drive lever is rotatably disposed with respect to a first axis and is connected to the drive motor, wherein the output lever is rotatably disposed with respect to a second axis and is connected to the flap.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and the sole FIGURE shows a schematic representation of an exemplary embodiment of a torque transmission device of the invention of a heating, ventilation, or air conditioning system of a motor vehicle.

### DETAILED DESCRIPTION

The FIGURE shows, in a schematic representation, an exemplary embodiment of a torque transmission device 1 of the invention, as it can be used, for example, in a heating, ventilation, or air conditioning system 2 of a motor vehicle. In this regard, the torque transmission device is used to actuate a flap 3 or another element 3 to be driven by means of a driving element 4. Driving element 4 is preferably an electric motor, a pneumatic actuator, a hydraulic actuator, etc.

Torque transmission device 1, in particular for a flap 3 of a heating, ventilation, or air conditioning system 2 of a motor vehicle, has a drive lever 5, an output lever 6, and a connecting rod 7.

Drive lever 5 can be rotatably disposed with respect to a first axis 8 and can be connected to driving element 4. Here, the FIGURE only schematically shows the rotatable arrangement with respect to axis 8.

Output lever 6 can be rotatably disposed with respect to a second axis 9 and can be connected to an element 3 to be driven. Here, the FIGURE only schematically shows the rotatable arrangement with respect to axis 9.

Connecting rod 7 is connected in an articulated manner to drive lever 5 and to output lever 6. For this purpose, a connecting joint 10, 11 is provided in each case.

According to the invention, connecting rod 7 is formed connected to drive lever 5 and/or to output lever 6 by means of a film hinge 12. Correspondingly, connecting joint 10 and/or connecting joint 11 or connecting joints 10, 11 are formed as a film hinge 12 or as film hinges 12. In an advantageous embodiment, connecting rod 7 is formed connected to drive lever 5 and to output lever 6 in each case by means of a film hinge 12.

With this design, connecting rod 7 and drive lever 5 can be formed in one piece or connecting rod 7 and output lever 6 can be formed in one piece or connecting rod 7, drive lever 5, and output lever 6 can be formed together in one piece.

For the case that both connecting joints 10, 11 are not formed as a film hinge 12, connecting joint 10, 11, which is not formed as a film hinge 12, between connecting rod 7 and drive lever 5 or with output lever 6 can be made as a positive connection, such as, for example, a ball head, pin, bayonet, clip, or plug connection, which is not shown in the FIGURE, however.

In the exemplary embodiment shown, it is particularly advantageous if connecting rod 7 and/or drive lever 5 and/or output lever 6 are manufactured as plastic parts, in particular as injection molded parts or extruded parts, etc. As a result, an efficient production can be achieved at low cost, wherein film hinge 12 or film hinges 12 can be produced in a very precisely reproducible manner in terms of their wall thickness, which allows the elasticity of film hinge 12 to be well defined.

The FIGURE shows that drive lever 5 has a receptacle 13 and/or a connecting element for connecting a drive shaft 14 of driving element 4. For this purpose, in the simplest case, drive shaft 14 can be inserted into receptacle 13 and secured by positive-locking measures in order to be able to transmit a torque. An approximately star-shaped inner profile 15 can be seen as positive-locking measures in the FIGURE, which, however, can also be formed as a square profile, or in general as a polygonal profile.

Output lever 6 is also designed such that it has a receptacle 16 and/or a connecting element for connecting to an element 3 to be driven. In this regard, element 3 to be driven can be a flap which can be connected to output lever 6, for example, via a plug connection. Optionally, output lever 6 could also be designed in one piece with flap 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A torque transmission device for a flap of a heating, ventilation, or air conditioning system of a motor vehicle, the torque transmission device comprising:
a drive lever;
an output lever; and
a connecting rod,
wherein the drive lever is adapted to be rotatably disposed with respect to a first axis and is connectable to a driving element,
wherein the output lever is adapted to be rotatably disposed with respect to a second axis and is connectable to an element to be driven,
wherein the connecting rod is connectable in an articulated manner to the drive lever and to the output lever,
wherein the connecting rod is formed connected to the drive lever and/or to the output lever via a film hinge.

2. The torque transmission device according to claim 1, wherein the connecting rod is formed connected to the drive lever and to the output lever in each case by a film hinge.

3. The torque transmission device according to claim 1, wherein the connecting rod and the drive lever are formed in one piece or the connecting rod and the output lever are formed in one piece or wherein the connecting rod, the drive lever, and the output lever are formed in one piece.

4. The torque transmission device according to claim 1, wherein the connection, not formed as a film hinge, between the connecting rod and the drive lever or with the output lever is made as a positive connection or by a ball head, pin, bayonet, clip, or plug connection.

5. The torque transmission device according to claim 1, wherein the connecting rod and/or the drive lever and/or the output lever are produced as plastic parts and/or as injection molded parts.

6. The torque transmission device according to claim 1, wherein the drive lever has a receptacle and/or a connecting element for connecting a drive shaft of a driving element.

7. The torque transmission device according to claim 1, wherein the driving element is an actuator, a stepper motor, an electric motor, or a Bowden cable.

8. The torque transmission device according to claim 1, wherein the output lever has a receptacle and/or a connecting element for connecting to an element to be driven, in particular to a flap.

9. A heating, ventilation, or air conditioning system of a motor vehicle comprising a flap for controlling an airflow in an air duct and with a drive motor for actuating the flap, wherein a torque transmission device is provided according to claim 1, wherein the torque transmission device is formed having a drive lever, an output lever, and a connecting rod, wherein the drive lever is rotatably disposed with respect to a first axis and is connected to the drive motor, and wherein the output lever is rotatably disposed with respect to a second axis and is connected to the flap.
